(19) United States
(12) Patent Application Publication
(10) Pub. No.: US 2025/0250201 A1
(43) Pub. Date: Aug. 7, 2025

(54) CEMENTITIOUS COMPOSITIONS AND SYSTEMS WITH ENHANCED SOLAR REFLECTANCE AND THERMAL EMITTANCE AND RELATED METHODS

(71) Applicant: Carbon Limit Co., Boca Raton, FL (US)

(72) Inventors: Leonard Timothy Sperry, III, Highland Beach, FL (US); Jitendra Arunchandra Jain, Edison, NJ (US); Gauthier Ducrozet, Miami, FL (US)

(73) Assignee: Carbon Limit Co., Boca Raton, FL (US)

(21) Appl. No.: 18/888,006

(22) Filed: Sep. 17, 2024

Related U.S. Application Data
(60) Provisional application No. 63/590,308, filed on Oct. 13, 2023.

(51) Int. Cl. C04B 14/22; C04B 14/04; C04B 14/30; C04B 22/10; C04B 111/00; C04B 111/80

(52) U.S. Cl. CPC C04B 14/22; C04B 14/047; C04B 14/305; C04B 22/10; C04B 2111/00448; C04B 2111/80

(57) ABSTRACT

Cementitious system and/or concrete compositions having enhanced sunlight reflectance and thermal emittance and related methods are generally described.

### RELATED APPLICATIONS

This application claims priority to U.S. Provisional Application No. 63/590,308, filed Oct. 13, 2023, entitled “CEMENTITIOUS COMPOSITIONS AND SYSTEMS WITH ENHANCED SOLAR REFLECTANCE AND THERMAL EMITTANCE AND RELATED METHODS,” which is incorporated herein by reference in its entirety for all purposes.

### TECHNICAL FIELD

Concrete and/or cementitious system compositions having enhanced solar reflectance and thermal emittance and related methods are generally described.

### BACKGROUND

Urban environments have various heat-absorbing materials, while suffering from scarce vegetation relative to non-urban areas and air polluted with, e.g., soot and greenhouse gases. As a result, urban areas trap heat and experience temperatures that are, on average, higher than surrounding suburban and/or rural areas, which is known as the urban heat island effect. The urban heat island effect can lead to increased energy usage to cool indoor space, elevate the risk of heat related illnesses, and/or disrupt local ecosystems from associated CO₂ emissions that arise from increased energy usage. Accordingly, systems and methods relate to reducing and/or preventing the urban heat island effect are needed.

### SUMMARY

Cementitious system compositions having enhanced Solar Reflectivity Index (SRI) (i.e., combined enhanced solar reflectance and thermal emittance) and related methods are generally described. In some such compositions and methods, the cementitious system contains or is made out of materials that may also have enhanced solar reflectance, enhanced thermal emittance and/or carbon-capturing features. The subject matter of the present disclosure involves, in some cases, interrelated products, alternative solutions to a particular problem, and/or a plurality of different uses of one or more systems and/or articles.

Some aspects are related to compositions.

In some embodiments, a cementitious system composition comprises a silicon-containing material; a light-reflecting material; and a thermal emittance enhancing material.

In some embodiments, a composition comprises a cementitious system composition comprising a silicon-containing material; a light-reflecting material comprising barium sulfate; and a thermal emittance enhancing material comprising pumice.

In some embodiments, a composition of variable thermal conductivity in concrete comprises a cementitious base material; an aggregate mixture; and an additive material selected from the group consisting of aerogels, expanded perlite, and vermiculite, wherein the additive material is dispersed within the concrete matrix in an amount ranging from 5% to 20% by volume, and wherein the thermal conductivity of the cured concrete is reduced by at least 30% relative to the thermal conductivity of a substantially identical composition absent the additive material.

In some instances, a concrete mixture with variable thermal conductivity comprises a cementitious binder; fine and coarse aggregates; and a polymeric insulating filler, wherein the polymeric insulating filler is a microencapsulated phase change material (PCM) present in an amount of at least 2 wt % and up to 10 wt % of the total concrete mixture, wherein the microencapsulated PCM is configured to reduce the thermal conductivity of the concrete mixture by at least 25% relative to a substantially identical concrete mixture absent the polymeric insulating filler.

In some embodiments, a concrete composition comprises hydraulic cement; water; aggregates; and a reflective pigment selected from the group consisting of zinc oxide, ceramic microspheres, and barium sulfate, wherein the reflective pigment is present in an amount effective to increase the solar reflectance index (SRI) of the concrete.

In some embodiments, the concrete composition comprises hydraulic cement; water; aggregates; and a supplementary cementitious material (SCM) selected from the group consisting of hollow glass microspheres and processed fly ash, wherein the SCM is present in an amount effective to replace up to 30% of the Portland cement by weight and to enhance the cooling effects of the concrete.

In some embodiments, a concrete composition comprises hydraulic cement; water; aggregates; and pumice with a GE brightness rating of 60 or higher, wherein the pumice is present in an amount effective to increase the albedo and Solar Reflectance Index (SRI) of the concrete, wherein the concrete composition is configured to reflect UV rays and visible light, thereby reducing heat absorption and minimizing heat transference through the concrete.

In some embodiments, a concrete composition comprises a binder phase including at least one of hydraulic cement and white cement; an aggregate phase including light-colored natural aggregates selected from the group consisting of marble, limestone, and light-colored sands; titanium dioxide in an amount effective to increase the reflectivity of the concrete; and optionally, glass or mirror particles integrated into the mix to further enhance solar reflectance and aesthetic appearance.

In some embodiments, a concrete composition for use in urban environments to reduce energy consumption related to air conditioning comprises a binder phase including white cement; an aggregate phase including at least one type of light-colored natural aggregate; titanium dioxide for increased reflectivity; and organic modifiers to adjust the mechanical properties and surface characteristics of the concrete.

In some embodiments, a concrete composition for use in urban environments to reduce energy consumption related to air conditioning comprises a binder phase including white cement; an aggregate phase including at least one type of light-colored natural aggregate; titanium dioxide for increased reflectivity; and organic modifiers, including but not limited to air-entrainer, to adjust the mechanical properties and surface characteristics of the concrete.

In some embodiments, a concrete composition for use in urban environments to reduce energy consumption related to air conditioning comprises hydraulic cement; an aggregate phase including at least one type of light-colored natural aggregate; titanium dioxide for increased reflectivity; and air entraining admixtures to facilitate the development of a system of microscopic air bubbles to change thermal conductivity.

Some aspects are related to methods.

In some embodiments, the method is a method for preparing a cementitious system. In some embodiments, the method comprises mixing a cementitious admixture and a cement, wherein the cementitious admixture comprises a silicon-containing material, a light-reflecting material, and a thermal emittance enhancing material.

In some embodiments, the method is a method for reducing heat generated by concrete. In some instances, the method comprises reflecting at least a portion of incident sunlight from the concrete and re-emitting at least a portion of absorbed solar energy, wherein the concrete comprises a cementitious system composition comprising a silicon-containing material; a light-reflecting material and a thermal emittance enhancing material and has an albedo of at least 0.22.

In some embodiments, the method is a method for producing concrete with variable thermal conductivity. In some embodiments, the method includes preparing a concrete mixture containing a cementitious binder and aggregate; incorporating a lightweight, porous material selected from the group consisting of expanded clay, pumice, and foamed glass into the mixture in an amount sufficient to achieve a density reduction of the concrete by at least 15% compared to conventional concrete; mixing the components to form a homogeneous mixture; and curing the concrete mixture to form a solid structure with a thermal conductivity reduced by at least 20% relative to a similar concrete structure without the lightweight, porous material.

In some embodiments, the method is a method of manufacturing a heat-reflective concrete. In some instances, the method comprises mixing cement, water, aggregates, and a UV reflective pigment comprising iron oxide pigments; pouring the mixture into a mold; and curing the mixture to form a concrete structure wherein the iron oxide pigments are distributed uniformly throughout the concrete to provide enhanced UV protection and thermal reflectivity.

In some embodiments, the method is a method of reducing the urban heat island effect in urban areas. In some embodiments, the method comprises producing a concrete mixture by replacing a portion of hydraulic cement with a cooling effective amount of a white or light-colored SCM; and constructing urban pavement and structures using the concrete mixture, wherein the concrete reflects a higher percentage of solar radiation compared to substantially identical concrete absent the SCM.

In some embodiments, the method is a method of manufacturing a cooling concrete. In some instances, the method comprises mixing a pumice with a GE brightness of at least 60 or higher with hydraulic cement, water, and aggregates to form a concrete mixture; pouring the concrete mixture into a predetermined form; and allowing the concrete mixture to cure, thereby forming a concrete structure with increased albedo and Solar Reflectance Index (SRI) capable of reducing urban heat island effects.

Some aspects are related to articles.

In some embodiments, a concrete article comprises a cementitious system composition, comprising: a silicon-containing material; a light-reflecting material; and a thermal emittance enhancing material.

In some embodiments, a concrete product with enhanced thermal insulation properties comprises a cement matrix; natural or synthetic fibers selected from the group consisting of cellulose, polypropylene, wherein the fibers present in the cement matrix at a volume fraction of at least 0.5% up to 5%; and an air-entraining agent present in an amount ranging from at least 0.05% up to 0.2% by weight of the concrete product, wherein the combination of fibers and air-entrainment reduces the thermal conductivity of the concrete product by at least 15% compared to a concrete product absent the fibers and air-entraining agent.

In some embodiments, a concrete article with variable thermal conductivity comprises a core made from a cementitious composition containing a blend of hydraulic cement and ground granulated blast-furnace slag (GGBFS); a lightweight aggregate selected from the group consisting of expanded shale and pumice; and a nanoparticle additive, wherein the nanoparticle additive is selected from silica aerogels or carbon nanotubes, incorporated at a concentration of 0.01% to 1% by weight of the cementitious composition, wherein the inclusion of the nanoparticle additive changes the thermal conductivity of the concrete block by at least 35% compared to a concrete block made without the nanoparticle additive.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 a schematic diagram showing concrete reflecting a portion of incident sunlight, according to some embodiments;

FIG. 2 is a plot of sunlight reflectance of various mortar samples measured by their albedo values, according to some embodiments;

FIG. 3 is a plot of the surface temperature of various mortar samples as a function of time, according to some embodiments;

FIG. 4 is a plot of the average surface temperature change of various mortar samples as observed in FIG. 3 as a function of albedo, according to some embodiments

FIG. 5 is an image of various mortar cube specimens, according to some embodiments; and

FIG. 6 is a plot of the surface temperature of control vs. sample concrete specimens as a function of time, according to some embodiments.

### DETAILED DESCRIPTION

Some aspects of the present disclosure are related to improved compositions of cementitious system that reflect sunlight and have high thermal emittance, and, as a result, can be mixed with concrete aggregates (e.g., fine aggregates, coarse aggregates) and cured to form sunlight-reflecting and high thermal emittance concrete. In some embodiments, the certain compositions or systems described herein may be applied in the form of low viscosity cement plaster or stucco formulations, e.g., by spraying or rolling, onto an existing surface of the cementitious structures. In some embodiments, the cementitious system compositions comprise a silicon-containing material (e.g., waste/recycled glass, SiO₂) and a sunlight-reflecting material (e.g., barium sulfate). In some embodiments, the enhanced solar reflectivity index materials comprise white marble granules or powders, ultra white calcium carbonate, aluminum oxide, aluminum hydroxide, white clay, titanium oxide, white volcanic ashes, white Portland cement, silicon carbide, aluminum nitride, magnesium oxide, magnesium hydroxide, and/or zirconium dioxide. By reflecting a portion of sunlight incident on concrete comprising the cementitious system compositions, the concrete absorbs less sunlight and generates less heat. Other aspects are related to methods of forming cementitious systems and/or using the compositions described by this disclosure.

Concrete is known to absorb heat (e.g., from sunlight or other incident light), and as a result, urban areas containing significant amounts of concrete may experience elevated temperatures when compared to surrounding suburban and/or rural areas. This is known as the urban heat island effect. Increased temperatures may lead to various problems, including increased instances of heat-related illnesses, increased energy usage to cool indoor environments, and related increases in emissions (e.g., CO₂ emissions). Accordingly, some aspects of the present disclosure are related to improved cementitious system and/or concrete compositions that reflect more sunlight than conventional concretes, and therefore, the resulting concrete heats less and mitigates the urban island effect, or heat otherwise generated by concrete. Additionally, it should be understood that while cementitious system and concrete compositions are generally described, the compositions described herein may also be used for additional applications, for example, as supplementary cementitious materials, cement admixtures, roofing materials, stucco materials, and/or 3D-printing ink.

In some embodiments, the cementitious system and/or concrete compositions described herein comprise mixtures of certain materials. In some embodiments, the cementitious system compositions comprise a silicon-containing material and a light-reflecting material. In some embodiments, a composition comprises a light-reflecting material and a cementitious system composition (e.g., comprising a silicon-containing material). In some cases, the cementitious systems compositions further comprise an inorganic material, a metal oxide, and/or a carbonate-containing compound. In some cases, the mixture of materials can replace at least a portion of conventional cements (e.g., Ordinary Portland Cement (OPC), Portland-Limestone Cement (PLC), blended cements, Sulphate Resisting Cement and equivalent white cementitious systems [i.e., white Ordinary Portland cement, white Portland Limestone Cement, etc.], hydraulic cements, ground granulated blast-furnace slag (GGBFS), cementitious binders and/or base materials) in concrete compositions, resulting in a concrete that can reflect incident sunlight at a higher rate than concrete compositions that do not comprise the mixture of materials. It will be understood that, in some embodiments, the cement systems and/or concrete compositions described herein may still contain at least a portion of conventional cement materials, e.g., as a base material, matrix, and/or binder.

In some embodiments, the compositions comprise a silicon-containing material. For example, in some embodiments, the silicon-containing material comprises waste glass. Waste glass may comprise discarded glass from other processes (e.g., recycled glass from consumer outputs, disposed of glass from industrial and/or construction sites). In some embodiments, waste glass is an amorphous material comprising silicon, calcium and sodium. In some embodiments, waste glass is an amorphous material comprising silica (SiO₂), calcium carbonate (CaCO₃), and/or sodium carbonate (Na₂CO₃). In some embodiments, waste glass is an amorphous material further comprising aluminum oxide, quicklime (CaO), magnesia (MgO), potassium oxide (K₂O), and/or sodium oxide (Na₂O). In some such cases, the presence of such compounds may be determined using x-ray fluorescence (XRF). In some embodiments, waste glass is present in the silicon-containing material and/or of the cement and/or concrete composition in an amount of greater than or equal to 0.01 wt %, greater than or equal to 3 wt %, greater than or equal to 6 wt %, greater than or equal to 9 wt %, greater than or equal to 12 wt %, greater than or equal to 15 wt %, greater than or equal to 18 wt %, greater than or equal to 21 wt %, greater than or equal to 24 wt %, greater than or equal to 27 wt %, greater than or equal to 30 wt %, greater than or equal to 35 wt %, or greater than or equal to 40 wt % of the silicon-containing material and/or of the cementitious system and/or concrete composition. In some embodiments, waste glass is present in the silicon-containing material and/or of the cementitious system and/or concrete composition in an amount of less than or equal to 40 wt %, less than or equal to 35 wt %, less than or equal to 30 wt %, less than or equal to 27 wt %, less than or equal to 24 wt %, less than or equal to 21 wt %, less than or equal to 18 wt %, less than or equal to 15 wt %, less than or equal to 12 wt %, less than or equal to 9 wt %, less than or equal to 6 wt %, or less than or equal to 3 wt % of the silicon-containing material and/or of the cementitious system and/or concrete composition. Combinations of the above-referenced ranges are also possible (e.g., greater than or equal to 3 wt % and less than or equal to 40 wt %). Other ranges are possible. The remaining weight percentage may be other components of the composition (e.g., a light-reflecting material, a metal oxide).

In some embodiments, the silicon-containing material is present in the cement and/or concrete composition (e.g., the cementitious system composition) in an amount of greater than or equal to 0.01 wt %, greater than or equal to 3 wt %, greater than or equal to 6 wt %, greater than or equal to 9 wt %, greater than or equal to 12 wt %, greater than or equal to 15 wt %, greater than or equal to 18 wt %, greater than or equal to 21 wt %, greater than or equal to 24 wt %, greater than or equal to 27 wt %, greater than or equal to 30 wt %, greater than or equal to 35 wt %, or greater than or equal to 40 wt % of the cementitious system and/or concrete composition. In some embodiments, the silicon-containing material is present in the cement and/or concrete composition (e.g., the cementitious system composition) in an amount of less than or equal to 40 wt %, less than or equal to 35 wt %, less than or equal to 30 wt %, less than or equal to 27 wt %, less than or equal to 24 wt %, less than or equal to 21 wt %, less than or equal to 18 wt %, less than or equal to 15 wt %, less than or equal to 12 wt %, less than or equal to 9 wt %, less than or equal to 6 wt %, or less than or equal to 3 wt % of the cementitious system and/or concrete composition. Combinations of the above-referenced ranges are also possible (e.g., greater than or equal to 3 wt % and less than or equal to 40 wt %). Other ranges are possible. The remaining weight percentage may be other components of the composition (e.g., a light-reflecting material, a metal oxide).

Compositions (e.g., cementitious system and/or concrete compositions) described herein comprise a light-reflecting material. In some embodiments, the light-reflecting material reflects at least 90% of incident light having a wavelength corresponding to at least a portion of the visible and/or IR and/or UV region of the electromagnetic spectrum. For instance, in some embodiments, the light-reflecting material reflects at least 90% of incident light having a wavelength of greater than or equal to 600 nm and/or less than or equal to 1200 nm. In some cases, the light-reflecting material imparts a relatively high reflectance to a composition comprising the light-reflecting material, for example, relative to a cementitious and/or concrete composition wherein the light-reflecting material is absent. In some cases, the light-reflecting material increases the solar reflectance index (SRI) of the composition comprising the light-reflecting material, relative to a substantially cementitious and/or concrete composition wherein the light-reflecting material is absent. Any of a variety of materials are suitable for use as the light-reflecting material, in accordance with some embodiments. For example, in some embodiments, the light-reflecting material comprises barium sulfate, but other light-reflecting materials are possible. For example, the light-reflecting material may comprise zing-oxide and/or ceramic microspheres. Other light-reflecting materials are possible, and are described in more detail elsewhere herein.

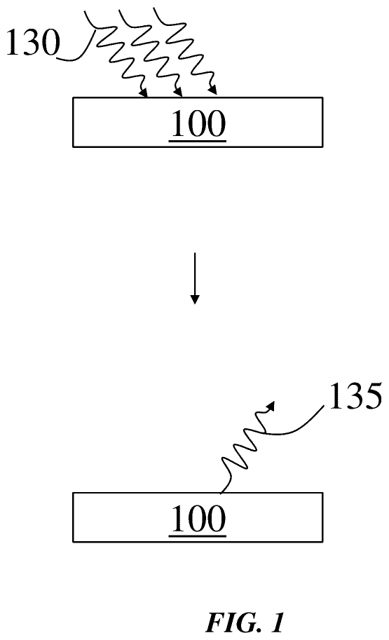

FIG. 1 is a schematic method flow diagram showing how an article as described herein may be used. FIG. 1 shows concrete 100 comprises a cementitious composition comprising a silicon-containing material (e.g., waste glass) and a light-reflecting material (e.g., barium sulfate). The concrete 100 may reduce the heat generated by concrete. As shown in FIG. 1, concrete 100 is irradiated by incident light 130. Incident light 130 is at least partially reflected by the concrete layer, as reflected light 135 in the figure. Accordingly, at least the portion of light corresponding to reflected light 135 is not absorbed by concrete layer 100, which lessens the amount of energy (e.g., heat) produced by the concrete layer 100 as it is irradiated with incident light 130. In some cases, an adjacent portion (e.g., an interior portion) receives less energy relative to another adjacent portion (e.g., an exterior portion, the atmosphere). In this manner, the adjacent portion may receive less heat than the other adjacent portion. In some such embodiments, the concrete is between the adjacent portion and the other adjacent portion.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) may also be present. Similarly, when a portion is “below” or “underneath” another portion, it can be directly below the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

In some embodiments, the light-reflecting material may be present in the cementitious system and/or concrete compositions in a variety of sizes. In some cases, the average particle size (e.g., diameter) of the light-reflecting material present in the cementitious system and/or concrete compositions is less than or equal to 20 μm, less than or equal to 15 μm, less than or equal to 10 μm, less than or equal to 5 μm, less than or equal to 2 μm, less than or equal to 1.5 μm, or less than or equal to 1 μm. In some embodiments, the average particle size of the light-reflecting material are present in the cementitious system and/or concrete compositions is greater than or equal to 1 μm, greater than or equal to 1.5 μm, greater than or equal to 2 μm, greater than or equal to 5 μm, greater than or equal to 10 μm, greater than or equal to 10 μm, greater than or equal to 15 μm, or greater than or equal to 20 μm. Combinations of the foregoing ranges are possible (e.g., greater than or equal to 1.5 μm and less than or equal to 10 μm, greater than or equal to 1 micron and less than or equal to 20 μm). Other ranges are also possible.

As described above, the sunlight-reflecting properties of the light-reflecting material, and of the cementitious system and/or concrete compositions comprising the light-reflecting material, may be advantageous for mitigating and/or preventing the sunlight absorption and thus reducing related increased heat or temperatures of such cementitious system and/or concrete compositions when light (e.g., sunlight) is incident upon the cementitious system and/or concrete. In some embodiments, reduction and/or prevention of sunlight absorption and related temperature increases may mitigate the urban heat island effect.

The light-reflecting material may be present in a cementitious system and/or concrete composition at a particular amount. For example, in some embodiments, a weight percentage of the light-reflecting material within the cementitious system and/or concrete composition is greater than or equal to 0.01 wt %, greater than or equal to 3 wt %, greater than or equal to 6 wt %, greater than or equal to 9 wt %, greater than or equal to 12 wt %, greater than or equal to 15 wt %, greater than or equal to 18 wt %, greater than or equal to 20 wt %, greater than or equal to 25 wt %, greater than or equal to 28 wt %, greater than or equal to 30 wt %, or greater than or equal to 35 wt %. In some embodiments, the weight percentage of the first material within the cementitious system and/or concrete composition is less than or equal to 35 wt %, less than or equal to 30 wt %, less than or equal to 28 wt %, less than or equal to 25 wt %, less than or equal to 20 wt %, less than or equal to 18 wt %, less than or equal to 15 wt %, less than or equal to 12 wt %, less than or equal to 9 wt %, less than or equal to 6 wt %, less than or equal to 3 wt %, or less than or equal to 0.01 wt %. Combinations of the above-referenced ranges are also possible (e.g., greater than or equal to 0.01 wt % and less than or equal to 35 wt %). Other ranges are possible. The remaining percentage may be another material (e.g., a silicon-containing material).

In some embodiments, cementitious system and/or concrete compositions described herein (e.g., containing the light-reflecting material) may exhibit as certain albedo (e.g., reflectivity) that is elevated relative to conventional cements and/or concrete compositions. In some embodiments, the elevated albedo (e.g., relative to conventional compositions) in the cementitious system and/or concrete compositions described herein arise, at least in part, due to the presence of the light-reflecting material. In accordance with some embodiments, the albedo of the cementitious system and/or concrete compositions is greater than or equal to 0.22, greater than or equal to 0.23, greater than or equal to 0.24, greater than or equal to 0.25, greater than or equal to 0.26, greater than or equal to 0.27, greater than or equal to 0.28, greater than or equal to 0.29, greater than or equal to 0.3, greater than or equal to 0.32, greater than or equal to 0.34, greater than or equal to 0.36, greater than or equal to 0.38, greater than or equal to 0.4, greater than or equal to 0.45, or greater than or equal to 0.5. In some embodiments, the albedo of the cementitious system and/or concrete compositions is less than or equal to 0.5, less than or equal to 0.45, less than or equal to 0.4, less than or equal to 0.38, less than or equal to 0.36, less than or equal to 0.34, less than or equal to 0.32, less than or equal to 0.3, less than or equal to 0.29, less than or equal to 0.28, less than or equal to 0.27, less than or equal to 0.26, less than or equal to 0.25, less than or equal to 0.24, less than or equal to 0.23, or less than or equal to 0.22. Combinations of the foregoing ranges are possible (e.g., greater than or equal to 0.22 and less than or equal to 0.5, greater than or equal to 0.23 and less than or equal to 0.5). Other ranges are also possible.

In some embodiments, the albedo of the cementitious system and/or concrete compositions described herein (e.g., containing the light-reflecting material) are higher than to conventional cements and/or concretes that do not contain the light-reflecting materials. For example, when compared to a control concrete comprising cement consisting of Ordinary Portland cement, the cementitious systems and/or compositions described herein have an albedo of 110%, greater than or equal to 120%, greater than or equal to 130%, greater than or equal to 140%, greater than or equal to 150%, greater than or equal 175%, greater than or equal 200% of the albedo of a conventional concrete (e.g., wherein a cement precursor of the conventional concrete consists of Ordinary Portland cement).

In some embodiments, the albedo of the cementitious system and/or concrete compositions, as described above, is related to incident light on a surface of the cementitious system and/or concrete compositions. In some embodiments, the incident light comprises and/or is sunlight. In some cases, the albedo describes the reflectivity of incident light by the cementitious system and/or concrete composition where the incident light comprises light of a wavelength of greater than or equal to 10 nm, greater than or equal to 50 nm, greater than or equal to 100 nm, greater than or equal to 200 nm, greater than or equal to 300 nm, greater than or equal to 400 nm, greater than 500 nm, greater than or equal to 600 nm, greater than or equal to 700 nm, greater than or equal to 800 nm, greater than or equal to or equal to 900 nm, greater than or equal to 1000 nm, greater than or equal to 1500 nm, greater than or equal to 2000 nm, greater than or equal to 2500 nm, greater than or equal to 3000 nm, greater than or equal to 3500, or greater than or equal to 4000 nm. In some cases, the albedo describes the reflectivity of incident light by the cementitious system and/or concrete composition where the incident light comprises light of a wavelength of less than or equal to 4000 nm, less than 3500 nm, less than or equal to 3000 nm, less than or equal to 2500 nm, less than or equal to 2000 nm, less than or equal to or equal to 1500 nm, less than or equal to 1000 nm, less than or equal to 900 nm, less than or equal to 800 nm, less than or equal to 700, less than or equal to 600 nm, less than or equal to 500, less than or equal to 400 nm, less than or equal to 300 nm, less than or equal to 200 nm, less than or equal to 100 nm, or less than or equal to 50 nm. Combinations of the foregoing ranges are possible (e.g., greater than or equal to 10 nm and less than or equal to 400 nm, greater than or equal to 400 nm and less than or equal to 700 nm, greater than or equal to 700 nm and less than or equal to 4000 nm, greater than or equal to 10 nm and less than or equal to 4000 nm). Other ranges are also possible.

In some embodiments, the cementitious system and/or concrete compositions has a particular thermal conductivity. In some embodiments, the thermal conductivity of the cementitious system and/or concrete composition is greater than or equal to 0.5 W m⁻¹ K⁻¹, greater than or equal to 0.7 W m⁻¹ K⁻¹, greater than or equal to 0.9 W m⁻¹ K⁻¹, greater than or equal to 1.1 W m⁻¹ K⁻¹, greater than or equal to 1.3 W m⁻¹ K⁻¹, greater than or equal to 1.5 W m⁻¹ K⁻¹, greater than or equal to 1.7 W m⁻¹ K⁻¹, greater than or equal to 1.9 W m⁻¹ K⁻¹, greater than or equal to 2 W m⁻¹ K⁻¹, greater than or equal to 3 W m⁻¹ K⁻¹, greater than or equal to 4 W m⁻¹ K⁻¹, or greater than or equal to 5 W m⁻¹ K⁻¹. In some cases, the thermal conductivity of the cementitious system and/or concrete composition is less than or equal to 5 W m⁻¹ K⁻¹, less than or equal to 4 W m⁻¹ K⁻¹, less than or equal to 3 W m⁻¹ K⁻¹, less than or equal to 2 W m⁻¹ K⁻¹, less than or equal to 1.9 W m⁻¹ K⁻¹, less than or equal to 1.7 W m⁻¹ K⁻¹, less than or equal to 1.5 W m⁻¹ K⁻¹, less than or equal to 1.3 W m⁻¹ K⁻¹, less than or equal to 1.1 W m⁻¹ K⁻¹, less than or equal to 0.9 W m⁻¹ K⁻¹, less than or equal to 0.7 W m⁻¹ K⁻¹, or less than or equal to 0.5 W m⁻¹ K⁻¹. Combinations of the foregoing ranges are possible (e.g., greater than or equal to 0.5 W m⁻¹ K⁻¹ and less than or equal to 5 W m⁻¹ K⁻¹ or greater than or equal to 0.5 W m⁻¹ K⁻¹ and less than or equal to 1.9 W m⁻¹ K⁻¹). Other ranges are also possible.

In some embodiments, due to the enhanced reflection of incident light (e.g., sunlight) of the cementitious system and/or concrete compositions described herein, the cementitious system and/or concrete compositions absorb less of the incident sunlight relative to conventional cements or concretes. Accordingly, in some such cases, a temperature of the cementitious system and/or concrete compositions described herein may increase less than conventional cement and/or concrete compositions that reflect less light. For instance, in some embodiments, a surface temperature increase of a concrete comprising the light-reflecting material, e.g., from before and after two hours of irradiation by sunlight, may be less than or equal to 2° C., less than or equal to 4° C., less than or equal to 6° C., less than or equal to 8° C., or less than or equal to 10° C. less than a temperature increase experienced by a conventional concrete, wherein a precursor to the conventional cement consisted of Ordinary Portland cement.

In some cases, the cementitious system and/or concrete composition further comprises an inorganic material. In some cases, the inorganic material comprises a porous inorganic material. In some embodiments, the inorganic material comprises one or more of zeolites. In some embodiments, the inorganic material comprises basalt. In some embodiments, the inorganic material comprises a pozzolanic material. In some embodiments, the inorganic material comprises a zeolite, a basalt, and/or a pozzolanic material. In some cases, the inorganic material may comprise mica, plagioclase, sienna, ochre, hematite and goethite, opaline cherts and shales, cerussite, zirconia silicate, recycled metals (e.g., aluminum, stainless steel, silver, copper, titanium) and/or other minerals (e.g., sphalerite). In some embodiments, the inorganic material may comprise olivine, perlite, wollastonite, MgO, and/or Mg(OH)₂.

The inorganic material may be present in a cementitious system and/or concrete composition at a particular amount. For example, in some embodiments, a weight percentage of the inorganic material within the cementitious system and/or concrete composition is greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt %. In some embodiments, the weight percentage of the first material within the cementitious system and/or concrete composition is less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less than or equal to 5 wt %. Combinations of the above-referenced ranges are also possible (e.g., greater than or equal to 5 wt % and less than or equal to 80 wt %). Other ranges are possible. The remaining percentage may be another material (e.g., a silicon-containing material, a light-reflecting material).

As mentioned above, in some embodiments, the inorganic material may comprise one or more zeolites. The one or more zeolites may each be a porous zeolite with the same or different composition. In some such embodiments, the zeolites comprise a honeycomb-like lattice structure. In some embodiments, the zeolites are porous materials comprising aluminosilicates. In some embodiments, the zeolite comprises clinoptilolite. In some embodiments, the zeolite is a naturally occurring zeolite. In some embodiments, the zeolite is a synthetic zeolite. In some embodiments, the zeolites can capture or sequester carbon dioxide via molecular binding (e.g., absorption, absorption, non-covalent interactions, covalent interactions) within pores of the zeolite. In some such embodiments, upon binding to the zeolite, the carbon dioxide may be converted to a carbonate compound (e.g., calcium carbonate) via carbonization of the first material or another material (e.g., a second material, a third material) in the composition.

In some embodiments, one or more zeolites may comprise a particular amount of the inorganic material and/or the cementitious system and/or concrete composition. For example, in some embodiments, a weight percentage of zeolite is greater than or equal to 5 wt %, greater than or equal to 10 wt %, greater than or equal to 20 wt %, greater than or equal to 30 wt %, greater than or equal to 50 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % in the inorganic material, the cementitious system composition, and/or the concrete composition. In some embodiments, a weight percentage of zeolite is less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 50 wt %, less than or equal to 30 wt %, less than or equal to 20 wt %, less than or equal to 10 wt %, or less than or equal to 5 wt % in the inorganic material, the cementitious system composition, and/or the concrete composition. Combinations of the above-referenced ranges are also possible (e.g., greater than or equal to 5 wt % and less than or equal to 90 wt %). Other ranges are possible. The remaining percentage, if any, may be another zeolite, another inorganic material, and/or some other material (e.g., a silicon-containing material, a light-reflecting material).

As mentioned above, the inorganic material may be a porous inorganic material (e.g., a zeolite). The inorganic material may have a particular porosity. In some embodiments, the porosity of the inorganic material is greater than or equal to 10%, greater than or equal to 20%, greater than or equal to 30%, greater than or equal to 40%, greater than or equal to 50%, greater than or equal to 60%, greater than or equal to 70%, or greater than or equal to 80%. In some embodiments, the porosity of the inorganic material is less than or equal to 80%, less than or equal 70%, less than or equal to 60%, less than or equal to 50%, less than or equal to 40%, less than or equal to 30%, less than or equal to 20%, or less than or equal to 10%. Combinations of the above referenced ranges are also possible (e.g., greater than or equal to 10% and less than or equal to 80%). Other ranges are possible.

In some embodiments, inorganic material (e.g., a zeolite) may have a particular average pore size. In some embodiments, the inorganic material has an average pore diameter of less than 1,000 μm, less than 750 μm, less than 500 μm, less than 250 μm, less than 100 μm, less than 50 μm, less than 25 μm, less than 20 μm, less than 10 μm, less than 1 μm, less than 750 nm, less than or equal to 500 nm, less than or equal to 250 nm, less than or equal to 100 nm, or less than or equal to 50 nm. In some embodiments, the inorganic material has an average pore diameter of greater than or equal to 50 nm, greater than or equal to 100 nm, greater than or equal to 200 nm, greater than or equal to 250 nm, greater than or equal to 500 nm, greater than or equal to 750 nm, greater than or equal to 1 μm, greater than or equal to 5 μm, greater than or equal to 10 μm, greater than or equal to 20 μm, greater than or equal to 25 μm, greater than or equal to 50 μm, greater than or equal to 100 μm, greater than or equal to 250 μm, greater than or equal to 500 μm, greater than or equal to 750 μm, or greater than or equal to 1,000 μm. Combinations of the foregoing ranges are also possible (e.g., greater than or equal to 50 nm and less than or equal to 1,000 μm). Other ranges are possible as this disclosure is not so limited. Note that the pore sizes described above may refer to at least one inorganic material present in the cementitious system and/or concrete compositions described herein, in accordance with some embodiments. In some cases, the pore sizes described above may refer to each inorganic material present in the cementitious system and/or concrete compositions. Still, in other cases, the pore sizes described above may refer to only some of the inorganic materials present in the cementitious system and/or concrete compositions, e.g., if more than one inorganic material is present.

As mentioned above, in some embodiments, the inorganic material comprises a basalt. Basalts include fine-grained (e.g., grain sizes less than 1000 μm) rocks formed from volcanic activity, which may also comprise a columnar structure. In some embodiments, basalts may comprise iron and/or magnesium compounds. In some embodiments, basalts comprise silica (e.g., SiO₂) and/or alkali metal oxides (e.g., Na₂O and K₂O).

In some embodiments, the basalt may be present in the inorganic material or the cementitious system and/or concrete composition in a particular amount. For example, in some embodiments, a weight percentage of basalt within the inorganic material, cementitious system, and/or the concrete composition is greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, or greater than or equal to 50 wt %. In some embodiments, the weight percentage of basalt within the inorganic material, cementitious system, and/or the concrete composition is less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt %. Combinations of the above-referenced ranges are also possible (e.g., greater than or equal to 5 wt % or less than or equal to 50 wt % or greater than or equal to 5 wt % or less than or equal to 35 wt %). Other ranges are possible. The remaining percent can be remaining inorganic material (e.g., zeolite, basalt) and/or some other material of the composition (e.g., a silicon-containing material, a light-reflecting material).

In some embodiments, the inorganic material comprises a pozzolanic material. Pozzolanic materials include naturally-derived materials and/or industrially produced material comprising a silicon-containing and/or aluminum-containing compounds that may react with calcium hydroxide when exposed to water. In some embodiments, the pozzolanic material comprises or is derived from volcanic ash. In some embodiments, the pozzolanic material comprises silicon-containing volcanic ash, volcanic tuffs or pumicites, fly ash, silica fume, metakaolin, slag (e.g., blast furnace flag), and/or vitrified calcium aluminosilicate. In some embodiments, the pozzolanic material comprises silicon-containing perlite. In some embodiments, the pozzolanic material may comprise diatomaceous earth, clays, rice hull ash, calcined fullers earth, calcined diatomite, uncalcined diatomite, zeolitic trass, and/or calcined clay. In some embodiments, the pozzolanic material comprises olivine, serpentine, basalts, wollastonite, calcium carbonate, and/or metal organic frameworks (MOFs). In some embodiments, the pozzolanic material comprises perlite. In some embodiments, the pozzolanic material comprises a mafic mineral (e.g., olivine, serpentine, wollastonite) and/or an ultramafic mineral.

The cementitious system and/or concrete compositions may also comprise a carbonate-containing compound. In some embodiments, the carbonate-containing compound has a fine particle size. In some embodiments, the finely-divided carbonate-containing compound increases the mineralization capacity of carbon dioxide within the cement and/or concrete composition. It should be understood that the carbonate-containing compound (e.g., the material that increases the mineralization capacity of carbon dioxide within the cement and/or concrete composition) is optional. In some embodiments, the carbonate-containing compound is not present in the compositions described herein.

In some embodiments, the compositions further comprise carbonate-containing compound. In some embodiments, the carbonate-containing compound comprises calcium carbonate. In some embodiments, the carbonate-containing compound comprises calcium carbonate (CaCO₃), sodium carbonate (Na₂CO₃), and/or potassium carbonate (K₂CO₃). In some embodiments, the calcium-containing compound comprises magnesium carbonate (MgCO₃).

In some embodiments, the carbonate-containing compound is present in the cementitious system and/or concrete composition in an amount of greater than or equal to 0.01 wt %, greater than or equal to 3 wt %, greater than or equal to 6 wt %, greater than or equal to 9 wt %, greater than or equal to 12 wt %, greater than or equal to 15 wt %, greater than or equal to 18 wt %, greater than or equal to 21 wt %, greater than or equal to 24 wt %, greater than or equal to 27 wt %, greater than or equal to 30 wt %, greater than or equal to 35 wt %, greater than or equal to 40 wt %, greater than or equal to 45 wt %, or greater than or equal to 50 wt % of the cementitious system and/or concrete composition. In some embodiments, the carbonate-containing compound is present in the cementitious system and/or concrete composition in an amount of less than or equal to 50 wt %, less than or equal to 45 wt %, less than or equal to 40 wt %, less than or equal to 35 wt %, less than or equal to 30 wt %, less than or equal to 27 wt %, less than or equal to 24 wt %, less than or equal to 21 wt %, less than or equal to 18 wt %, less than or equal to 15 wt %, less than or equal to 12 wt %, less than or equal to 9 wt %, less than or equal to 6 wt %, or less than or equal to 3 wt % of the cementitious system and/or concrete composition. Combinations of the above-referenced ranges are also possible (e.g., greater than or equal to 0.01 wt % and less than or equal to 50 wt %). Other ranges are possible.

Cementitious system and/or concrete compositions described herein may comprise a metal oxide. In some embodiments, the metal oxide may alter the pore size of other materials in the mixture (e.g., the pore size of the inorganic material). Advantageously, the metal oxide may also improve the overall compressive strength of the cementitious system composition and/or the resulting concrete and may also reduce water loss (and/or shrinking as a result of water loss) of the cementitious system composition and/or the resulting concrete. In some embodiments, the metal oxide may be a transition metal oxide. In some such embodiments, the metal oxide comprises titanium dioxide (TiO₂). Additional non-limiting examples of metal oxides include zirconium oxide, hafnium oxide, zinc oxide, and/or iron oxide. Other metal oxides are possible as this disclosure is not so limited.

The metal oxide may be present in a cementitious system and/or concrete composition at a particular amount. For example, in some embodiments, a weight percentage of the metal oxide within the cementitious system and/or concrete composition is greater than or equal to 0.01 wt %, greater than or equal to 0.1 wt %, greater than or equal to 0.5 wt %, greater than or equal to 1 wt %, greater than or equal to 2 wt %, greater than or equal to 3 wt %, greater than or equal to 4 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, or greater than or equal to 40 wt %. In some embodiments, the weight percentage of the metal oxide within the cementitious system and/or concrete composition is less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 4 wt %, less than or equal to 3 wt %, less than or equal to 2 wt %, less than or equal to 1 wt %, less than or equal to 0.5 wt %, or less than or equal to 0.1 wt %. Combinations of the above-referenced ranges are also possible (e.g., greater than or equal to 0.1 wt % and less than or equal to 20 wt % or greater than or equal to 0.1 wt % and less than or equal to 10 wt %). Other ranges are possible. The remaining percentage may be another material (e.g., a silicon-containing material, a light-reflecting material, an inorganic material), as described elsewhere herein.

As mentioned above, in some embodiments, the metal oxide comprises titanium dioxide. In some embodiments, titanium dioxide is crystalline and may promote the uptake of carbon dioxide. The diameter (e.g., the average diameter) of the titanium dioxide particles may be greater than or equal to 0.5 nm, greater than or equal to 1 nm, greater than or equal to 25 nm, greater than or equal to 50 nm, greater than or equal to 100 nm, greater than or equal to 250 nm, greater than or equal to 500 nm, greater than or equal to 1 μm, greater than or equal to 25 μm, greater than or equal to 100 μm, greater than or equal to 250 μm, or greater than or equal to 500 μm. In some embodiments, the diameter of the titanium dioxide particles is less than or equal to 500 μm, less than or equal to 250 μm, less than or equal to 100 μm, less than or equal to 25 μm, less than or equal to 1 μm, less than or equal to 500 nm, less than or equal to 250 nm, less than or equal to 100 nm, less than or equal to 50 nm, less than or equal to 25 nm, less than or equal to 1 nm, or less than or equal to 0.5 nm. Combinations of the above-referenced ranges are also possible (e.g., greater than or equal to 0.5 nm and less than or equal to 500 μm). Other ranges are possible.

In some cases, the mixture of materials (e.g., the silica-containing material and the light-reflecting material; the light-reflecting material, a zeolite, and a metal oxide) is an admixture that can be added to existing cement compositions in order to enhance the light-reflecting ability of the resultant concrete. In some such embodiments, the mixture of materials is an admixture that can be added to existing cement compositions in order to enhance and/or carbon-capturing ability of the resultant concrete formed from the cement composition. For example, a mixture of an inorganic material (e.g., a pozzolanic material and/or a zeolite), a metal oxide (e.g., titanium oxide), and a light-reflecting material (e.g., barium sulfate) forms an admixture, and this admixture can be added to other concrete-forming materials (e.g., coarse aggregates, fine aggregates, light-colored natural aggregates such as marble, limestone, and light-colored sands, water) such that the resulting concrete can reflect a larger portion of incident light (e.g., sunlight) relative to conventional concretes. This concrete can be incorporated into a variety of structures (e.g., buildings, roads, sidewalks, vertical or inclined external walls, and/or rooftops), some of which may be exposed to incident sunlight, therefore allowing the cement and/or concrete compositions as described herein reflect more light when compared to conventionally used cement and/or concrete compositions, in some cases. In some cases, the resulting concrete containing the above-described admixture may capture carbon dioxide (e.g., from the ambient environment) at an increased rate, relative to conventional concretes that do not contain the admixture as described above. In some such embodiments, the concrete may passively remove carbon dioxide directly from the atmosphere at ambient conditions without any special instrumentations and/or equipment.

Some of the cementitious or concrete systems and compositions described herein may further include one or more additives. Additives may be dispersed within a matrix (e.g., a concrete matrix) of the cementitious or concrete system and composition, e.g., homogeneously. In other instances, an additive may be heterogeneously dispersed within a matrix of the system or composition. In some embodiments, the additives may vary the thermal conductivity and/or heat conductivity of the cement or concrete, e.g., relative to cement or concrete absent the additive.

Any of a variety of suitable additives may be included in the system or composition. For example, in some embodiments, additives such as aerogels, expanded perlite, and/or vermiculite may be included, which may desirably reduce the thermal conductivity of the system of composition, relative to a substantially identical system or composition absent the additive. In some cases, additives such as a polymeric insulating filler (e.g., a microencapsulated phase change material (PCM)) may be included, which may desirably reduce the thermal conductivity of the system of composition, relative to a substantially identical system or composition absent the additive. In some cases, additives such as a lightweight porous material (e.g., expanded clay, expanded shale, pumice such as pumice having a GE brightness of at least 60 and/or less than 100, and/or foamed glass) may be included, which may desirably reduce the density and/or the thermal conductivity of the system of composition, relative to a substantially identical system or composition absent the additive. In some cases, additives such as a natural or synthetic fiber (e.g., cellulose fibers, polypropylene fibers, basalt fibers) may be included. In some such embodiments, the system or composition may further include an air entraining agent, which, in combination with the natural or synthetic fibers, may desirably reduce the density and/or the thermal conductivity of the system of composition, relative to a substantially identical system or composition absent the additive. In some cases, additives such as nanoparticle additives (e.g., silica aerogels and/or carbon nanotubes) may be included, which may desirably reduce the thermal conductivity of the system of composition, relative to a substantially identical system or composition absent the additive. In some embodiments, the additive includes a UV reflective pigment such as iron oxide pigments, which may provide desirably enhanced UV protection and/or thermal reflectivity. In some embodiments, the additive comprises a supplementary cementitious material (SCM; e.g., white aggregates, light-colored aggregates, white SCM, light-colored SCM, hollow glass microspheres, and/or processed fly ash). Such an SCM may be used in place of at least a portion of cement in typical cementitious compositions. For example, in some embodiments the SC may replace at least 5 wt % at least 10 wt %, at least 15 wt %, at least 20 wt %, and/or up to 25 wt % or up to 25 wt % of cement in a typical cementitious composition, and may enhance the cooling effects of the resulting concrete. In some embodiments, the additive may comprise glass and/or mirror particles, photocatalytic agents, and/or organic modifiers.

Additives may be present in the cementitious or concrete systems or compositions in any of a variety of suitable amounts. For example, the additive may be present in an amount of at least 0.5% by volume (vol %), at least 1 vol %, at least 5 vol %, or at least 10 vol %, and/or up to 15 vol %, or up to 20 vol % of the system or composition. In some embodiments, the additive may be present in an amount of at least 0.01 wt %, at least 0.05 wt %, at least 0.02 wt %, at least 0.1 wt %, at least 1 wt %, at least 2 wt %, at least 4 wt %, and/or up to 6 wt %, up to 8 wt %, or up to 10 wt % of the system or composition. Other amounts and ranges in which the additive may be present in the system or composition are also contemplated, as this disclosure is not so limited. In some embodiments, the cementitious systems and compositions have a low density compared to conventional cements or compositions. For instance, in some embodiments, the cementitious systems and compositions described herein comprise an additive including an expanded clay, pumice, and/or foamed glass, which may reduce the density of the composition relative to substantially identical compositions absent the additive. In some embodiments, the density of a cementitious system and/or composition as described herein may have a density that is reduced by at least 15%, at least 20%, at least 25%, at least 30%, at least 35%, at least 40%, or at least 50% and/or up to 60%, up to 70%, or up to 80%, relative to a substantially identical concrete without any of the foregoing additives.

In some embodiments, the cementitious systems and compositions have a low thermal conductivity compared to conventional cements or compositions. For instance, in some embodiments, the cementitious systems and compositions described herein comprise an additive including an expanded clay, pumice, air-entraining additive or admixture, and/or foamed glass, which may reduce the thermal conductivity of the composition relative to substantially identical compositions absent the additive. In some such embodiments, the thermal conductivity of a cementitious system and/or composition as described herein may have a conductivity that reduced at least 20%, at least 25%, at least 30%, at least 35%, at least 40%, or at least 50% and/or up to 60%, up to 70%, or up to 80%, relative to a substantially identical concrete without any of the foregoing additives.

Some aspects are related to methods of using the cementitious system and/or concrete compositions described herein. In some cases, as shown in the non-limiting example embodiment of FIG. 1, concrete can reflect at least a portion of incident light. In some such cases, reflecting the incident light by the concrete results in the concrete absorbing less of the incident light, and thereby heating less.

In some embodiments, the cementitious system and/or concretes described herein may reflect at least a portion of incident light. In some such cases, the amount of reflected light is enhanced relative to conventional concretes that do not contain the materials described herein (e.g., a light-reflecting material). In some cases, the incident light comprises or is sunlight. Accordingly, in some embodiments, the cementitious system and/or concretes described herein may exhibit a solar reflectance. In some embodiments, solar reflectance may be measured according to an ASTM E1980-11 standard test. In some cases, a solar reflectance of the cementitious system and/or concrete as determined by an ASTM E1980-11 standard test is greater than or equal to 0.1, greater than or equal to 0.2, greater than or equal to 0.3, greater than or equal to 0.4, greater than or equal to 0.5, greater than or equal to 0.6, greater than or equal to 0.7, greater than or equal to 0.8, or greater than or equal to 0.9. In some embodiments, a solar reflectance of the cementitious system and/or concrete as determined by an ASTM E1980-11 standard test is less than or equal to 0.9, less than or equal to 0.8, less than or equal to 0.7, less than or equal to 0.6, less than or equal to 0.5, less than or equal to 0.4, less than or equal to 0.3, less than or equal to 0.2, or less than or equal to 0.1. Combinations of the foregoing ranges are possible (e.g., greater than or equal to 0.1 and less than or equal to 0.9, greater than or equal to 0.4 and less than or equal to 0.9). Other ranges are also possible.

In some embodiments, the solar reflectivity properties of the cementitious systems described herein may be measured by ASTM C1864-Standard Test Method for Determination of Solar Reflectance of Directionally Reflective Material Using Portable Solar Reflectometer, ASTM C1594-Standard Test Method for Determination of Solar Reflectance Near Ambient Temperature Using a Portable Solar Reflectometer, ASTM C1483-Standard Specification for Exterior Solar Radiation Control Coatings on Buildings, ASTM E1980-Standard Practice for Calculating Solar Reflectance Index of Horizontal and Low-Sloped Opaque Surfaces, ASTM E903-Standard Test Method for Solar Absorptance, Reflectance, and Transmittance of Materials Using Integrating Spheres, ASTM 1918-Standard Test Method for Measuring Solar Reflectance of Horizontal and Low-Sloped Surfaces in the Field, ASTM E1175-Standard Test Method for Determining Solar or Photopic Reflectance, Transmittance, and Absorptance of Materials Using a Large Diameter Integrating Sphere, ASTM E424-Standard Test Methods for Solar Energy Transmittance and Reflectance (Terrestrial) of Sheet Materials, ASTM D7897-Standard Practice for Laboratory Soiling and Weathering of Roofing Materials to Simulate Effects of Natural Exposure on Solar Reflectance and Thermal Emittance, and/or ASTM E972-Standard Test Method for Solar Photometric Transmittance of Sheet Materials Using Sunlight.

In some embodiments, there is a temperature difference between a first region of the atmosphere approximately 1 meter directly above the concrete layer and a second region of the atmosphere approximately 1 meter directly above a natural area (e.g., a rural area wherein no concrete is present). In some such cases, the first and second region in the atmosphere are located within a 10 mile radius of each other. According to some embodiments, the temperature difference between the first and regions of the atmosphere is greater than or equal to 1° C., greater than or equal to 2° C., greater than or equal to 3° C., greater than or equal to 4° C., greater than or equal to 5° C., greater than or equal to 8° C., greater than or equal to 10° C., greater than or equal to 15° C., or greater than or equal to 20° C. In some cases, the temperature difference between the first and regions of the atmosphere is less than or equal to 20° C., less than or equal to 15° C., less than or equal to 10° C., less than or equal to 8° C., less than or equal to 5° C., less than or equal to 4° C., less than or equal to 3° C., less than or equal to 2° C., or less than or equal to 1° C. Combinations of the foregoing ranges are possible (e.g., greater than or equal to 1° C. and less than or equal to 20° C.). Other ranges are also possible.

In some embodiments, mixtures containing the silicon-containing material, the light-reflecting material, the inorganic material, the metal oxide, and/or the carbonate-containing compound form admixtures that can be added to existing cementitious system and/or concrete compositions. For example, in some embodiments, a mixture comprises a silicon-containing material (e.g., waste glass) and a light-reflecting material (e.g., barium sulfate). In some such embodiments, and this mixture can be an admixture that can be added to existing cementitious system and/or concrete mixtures. In some such embodiments, the admixture enhances the ability of the existing cementitious system and/or concrete composition to reflect light. For instance, in some embodiments, a mixture comprises a silicon-containing material (e.g., waste glass), a light-reflecting material (e.g., barium sulfate), an inorganic material (e.g., a zeolite), and/or a metal oxide (e.g., titanium dioxide). In some such embodiments, this mixture can be an admixture that can be added to existing cementitious system and/or concrete mixtures. Accordingly, in some embodiments, methods may include adding an admixture to a cementitious system, cementitious composition, and/or concrete mixture. In some embodiments, such an admixture may be present in the form of a sprayable cement plaster or stucco. In accordance with some such embodiments, the cement plaster or stucco can be sprayed or rolled onto an already existing concrete surface(s). In some embodiments, such a wet concrete, cement plaster or stucco can be applied as a final surface layer on wet concrete prior to its setting. For instance, in some embodiments, a method may include spraying, rolling, or otherwise applying a low viscosity cement plaster or stucco onto an existing concrete surface. In some embodiments, a method may include spraying, rolling, or otherwise applying a wet concrete, cement plaster or stucco onto wet concrete, i.e., before the wet concrete sets. In some instances, the admixture may be applied to an existing surface as a coating having an average thickness of at least 0.1 mm, at least 1 mm, at least 5 mm, at least 10 mm, at least 25 mm, or at least 50 mm, and/or up to 75 mm, or up to 100 mm. In some embodiments, the admixture enhances the ability of the existing cementitious system and/or concrete composition to reflect light and/or absorb carbon dioxide.

The cementitious system compositions comprising a silicon-containing material, a light-reflecting material, an inorganic material, a metal oxide material, and/or a carbonate-containing compound (e.g., a silicon-containing material, a light-reflecting material, an inorganic material, a metal oxide material, and a carbonate-containing compound; a silicon-containing material and a light-reflecting material, etc.) may be used to form concrete (e.g., concrete compositions, concrete mixtures). Accordingly, various embodiments are described in which concrete comprises a cement composition along with another component, such as a concrete-forming material. Concrete-forming materials include pastes that can bind cementitious and/or concrete materials together to form solid concrete (e.g., after curing the concrete mixture).

In some embodiments, concrete (e.g., a concrete composition, a concrete mixture) comprises a mixture of a light-reflecting material, an inorganic material, a metal oxide material, and/or a carbonate-containing compound. In some embodiments, concrete (e.g., a concrete composition, a concrete mixture) comprises a mixture of the silicon-containing material, the light-reflecting material, the inorganic material, the metal oxide material, and/or the carbonate-containing compound. In some embodiments, the silicon-containing material, the light-reflecting material, the inorganic material, the metal oxide material, and/or the carbonate-containing compound is greater than or equal to 0.01 wt %, greater than or equal to 0.05 wt %, greater than or equal to 0.1 wt %, greater than or equal to 1 wt %, greater than or equal to 2 wt %, greater than or equal to 3 wt %, greater than or equal to 5 wt %, greater than or equal to 10 wt %, greater than or equal to 15 wt %, greater than or equal to 20 wt %, greater than or equal to 25 wt %, or greater than or equal to 30 wt % of the total weight of the concrete composition. In some embodiments, the silicon-containing material, the light-reflecting material, the inorganic material, the metal oxide material, and/or the carbonate-containing compound is less than or equal to 30 wt %, less than or equal to 25 wt %, less than or equal to 20 wt %, less than or equal to 15 wt %, less than or equal to 10 wt %, less than or equal to 5 wt %, less than or equal to 3 wt %, less than or equal to 2 wt %, less than or equal to 1 wt %, less than or equal to 0.1 wt %, less than or equal to 0.05 wt %, or less than or equal to 0.01 wt % of the total weight of the concrete composition. Combinations of the above-referenced ranges are also possible (e.g., greater than or equal to 0.01 wt % and less than or equal to 15 wt % or greater than or equal to 0.01 wt % and less than or equal to 30 wt %). Other ranges are possible. The remaining balance for the total weight of the concrete composition may be another of the silicon-containing material, the light-reflecting material, the inorganic material, the metal oxide material, and/or the carbonate-containing compound, and/or one or more concrete-forming materials (e.g., concrete aggregates, paste, water).

In some embodiments, wherein Ordinary Portland cement may have originally been used to form concrete, at least a portion of the Ordinary Portland cement may be replaced by the mixtures and/or admixtures described herein. For example, in some embodiments, at least a portion of the Ordinary Portland cement is replaced by a mixture comprising the silicon-containing material, the light-reflecting material, the inorganic material, the metal oxide material, and/or the carbonate-containing compound. In some such embodiments, the mixture replaces at least 1 wt %, at least 2 wt %, at least 3 wt %, at least 4 wt %, at least 5 wt %, at least 8 wt %, at least 10 wt %, at least 20 wt %, at least 30 wt %, at least 40 wt %, or at least 50 wt % of the Ordinary Portland cement (e.g., for use in concrete). In some embodiments, the mixture replaces no more than 50 wt %, no more than 40 wt %, no more than 30 wt %, no more than 20 wt %, no more than 10 wt %, no more than 8 wt %, no more than 5 wt %, no more than 4 wt %, no more than 3 wt %, no more than 2 wt %, no more than 1 wt % of the Ordinary Portland cement (e.g., for use in concrete). Combinations of the foregoing ranges are possible (e.g., at least 1 wt % and no more than 3 wt % of the Ordinary Portland cement, at least 10 wt % and no more than 50 wt % of the Ordinary Portland cement). Other ranges are also possible.

In some embodiments, the cementitious system composition (e.g., comprising the silicon-containing material, the inorganic material, the metal oxide material, and/or the carbonate-containing compound) may comprise particles of a particular particle size. In some cases, the particle size of components of the cementitious system composition (e.g., the silicon-containing material, the inorganic material, the metal oxide material, and/or the carbonate-containing compound) may be reduced before being introduced into the cement composition. For example, in some embodiments, an average particle dimension (e.g., diameter) in the cement is less than or equal to 3000 μm, less than or equal to 2000 μm, less than or equal to 1000 μm, less than or equal to 750 μm, less than or equal to 500 μm, less than or equal to 250 μm, less than or equal to 100 μm, less than or equal to 50 μm, less than or equal to 20 μm, less than or equal to 10 μm, or less than or equal to 1 μm. In some embodiments, an average particle dimension is greater than or equal to 1 μm, greater than or equal to 20 μm, greater than or equal to 50 μm, greater than or equal to 100 μm, greater than or equal to 250 μm, greater than or equal to 500 μm, greater than or equal to 750 μm, greater than or equal to 1,000 μm, greater than or equal to 2,000 μm, or greater than or equal to 3,000 μm. Combinations of the above-reference ranges are also possible (e.g., greater than or equal to 1 μm and less than or equal to 1,000 μm). Other ranges are possible.

In some embodiments, the composition described herein are relatively resistant to degradation by exposure to certain chemicals. For example, due to the silicon-containing materials, in some embodiments, the compositions described herein may be resistant to chloride penetration. The resistance to chloride penetration, in some embodiments, may be measured by an ASTM C1202-22e1 standard test. In some such embodiments, the concrete may pass less than or equal to 2000 coulombs, less than or equal to 1000 coulombs, less than or equal to 500 coulombs, less than or equal to 100 coulombs, or less than or equal to 10 coulombs of charge over the course of the standard test (e.g., over six hours). Such resistance to chloride penetration, as well as resistance to other reactive chemicals like sulfates, salts, and acids, may result in concrete with an increased durability compared to conventional concretes.

In some embodiments, the temperature of the surfaces of concrete comprising the cementitious systems or compositions as described herein may be measured by using thermocouples, infrared thermometers, i-buttons, heat flux sensors, or any other suitable temperature monitoring device. In some cases, when using heat flux sensors, the power density in Watt/cm² units may also be measured. Accordingly, when heat flux sensors are used to measure the temperature of the surfaces, it is possible to directly measure the energy savings accomplished by the using the compositions and systems described herein with respect to a control surface containing none of the cementitious systems or compositions described herein. In some embodiments, the temperature of the surface may be measured and/or monitored for at least 1 day, at least 1 week, at least 3 weeks, and/or up to 5 weeks, or up to 8 weeks. In some embodiments, the cementitious systems or compositions and/or the properties thereof do not substantially degrade or change over time. In some such embodiments, degradation and/or changing of the systems or compositions or the properties thereof may be monitored long-term, e.g., using any suitable temperature monitoring device as described above.

Some aspects are related to methods of making and/or using the systems and compositions described herein. For instance, in some embodiments, a method may include mixing various components of the systems or compositions together. In some embodiments, the method may further include pouring such a mixture into a mold or frame and/or allowing the mixture to cure. In some embodiments, the method may include forming pavement, roofing tiles, walls, and/or structures using the concrete mixture. In some embodiments, methods may include applying the concrete mixture to an existing surface, e.g., a wall, roofing tiles, or pavement, such that the mixture may impart desirable properties (e.g., enhanced reflectivity, decreased thermal conductivity, etc.) to the existing surface. Such desirable properties, in some instances, may reduce an urban heat island effect, thereby decreasing temperatures in certain urban spaces and advantageously decreasing energy consumption associated therewith (e.g., due to cooling an interior of a building).

The following examples are intended to illustrate certain embodiments of the present invention, but do not exemplify the full scope of the invention.

### Example 1

This example describes the light-reflecting properties of concrete made with mortar samples comprising a cementitious system composition comprising a metal oxide, titanium dioxide, and a silicon-containing material, waste glass, and their measured properties.

Samples were prepared by casting and curing the mortar samples containing the cementitious composition following ASTM C305 Standard practice. All components were individually weighted using a calibrated laboratory balance scale and following the mixture proportions indicated in TABLE 1 below (ambient temperature between 2° and 27.5° C., humidity not less than 50%). Then, a measured amount of tap water (at approximately 23° C.) was directly inserted into the mortar mixing bowl and cement was added to water. The mixture was placed on a electrically driven mechanical mortar mixer and mixed for 30 seconds, at low speed (140±5 r/min), using a stainless steel paddle. After 30 seconds, a measured quantity of ASTM C778 graded Ottawa test sand (natural silica sand graded to retain 98% on a No. 100 (150μ) sieve, 75% on a No. 50 (300μ) 30% on a No. 40 (425μ) and 2% on a No. 30 (600μ)) was added in the bowl over a 30 second period. After 30 seconds, mixing speed is switched to high speed (285±10 r/min) for 30 more seconds. After a total of 90 seconds, mixer is turned off for 90 seconds and the sides of the bowl are scrapped down during the first 15 seconds. Finally, the mortar is mixed again at high speed for 60 seconds. After these 240 seconds of mixing, mortar is cast in 2×2×2 [in] mortar cube molds and kept in a moist environment (at approximately 23° C., humidity not less than 95%) for 24 hours. Then, mortar cubes were removed from the molds and cured in tap water (approximately 23° C.) buckets for 6 more days. A control sample was made, comprising Portland-Limestone cement, ASTM C778 Standard graded sand and tap water. Nine test samples were also made, where each of the nine samples comprised materials as described in TABLE 1.

TABLE 1
Mix proportions for the 2 × 2 × 2 in mortar cube specimens.

| | PLC | ASTM | | | VCAS glass | MG 80 Glass | |
|---|---|---|---|---|---|---|---|
| Mix ID | cement [g] | sand [g] | Water [g] | TiO₂ [g] | 140 [g] | sand [g] | Zeolite [g] |
| Control | 740.00 | 2,035.00 | 384.80 | — | — | — | — |
| SC-1 | 400.00 | 1,375.00 | 260.00 | — | — | — | — |
| SC-2 | 500.00 | 1,375.00 | 260.00 | 25.00 | — | — | — |
| SC-3 | 350.00 | 1,375.00 | 260.00 | — | 150.00 | — | — |
| SC-4 | 500.00 | 1,100.00 | 260.00 | — | — | 275.00 | — |
| SC-5 | 400.00 | 1,375.00 | 260.00 | — | — | — | 100.00 |
| SC-6 | 400.00 | 1,100.00 | 260.00 | — | — | 275.00 | 100.00 |
| SC-7 | 400.00 | 1,100.00 | 260.00 | 25.00 | — | 275.00 | 100.00 |
| SC-8 | 400.00 | 1,375.00 | 260.00 | 25.00 | — | — | 100.00 |
| SC-9 | 350.00 | 1,375.00 | 260.00 | 25.00 | 150.00 | — | — |

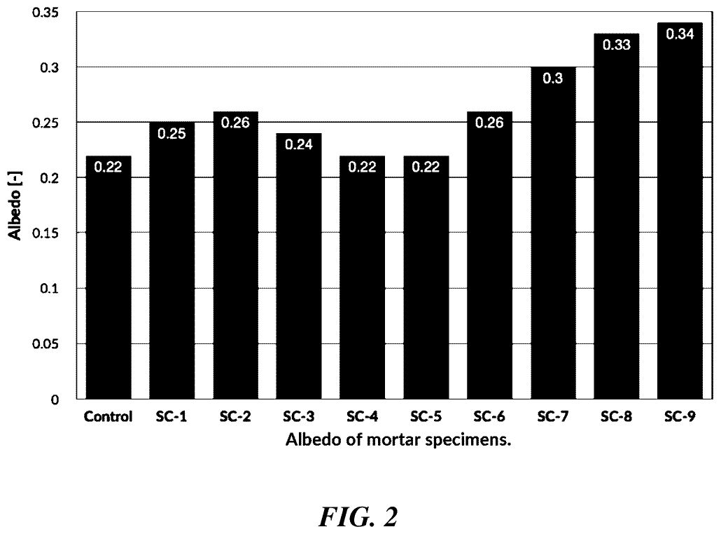

FIG. 2 shows the albedo for the 10 test samples. Notably, when compared to the control sample, multiple of the test samples exhibited increased albedo values. For example, in the case of test sample 9 (e.g., SC-9), an increase of more than 50% of the albedo value, relative to the control sample, was observed, indicating the test sample reflects significantly more light than the control sample.

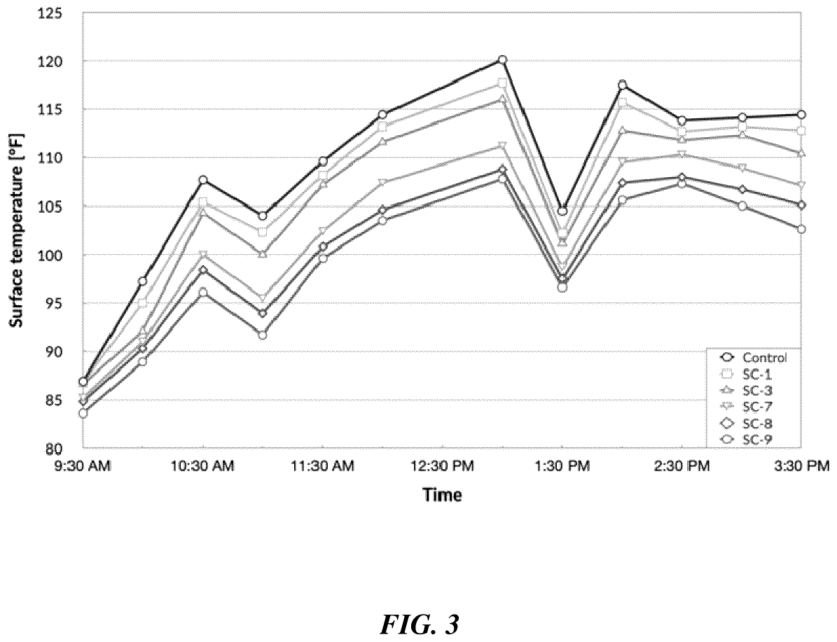

The surface temperature of each sample was also recorded in 30-minute intervals throughout the day to understand the relationship between the albedo observed for each sample and the resultant surface temperature. FIG. 3 shows the surface temperature of each sample as a function of time. The plot shows the active cooling effect that results from the increased albedo in the test samples, relative to the control sample. For example, test sample 9 shows a maximum surface temperature difference between itself and the control sample of 8 degrees despite substantially identical conditions (e.g., irradiation by sunlight, temperature of atmosphere and ground, etc.) other than sample composition.

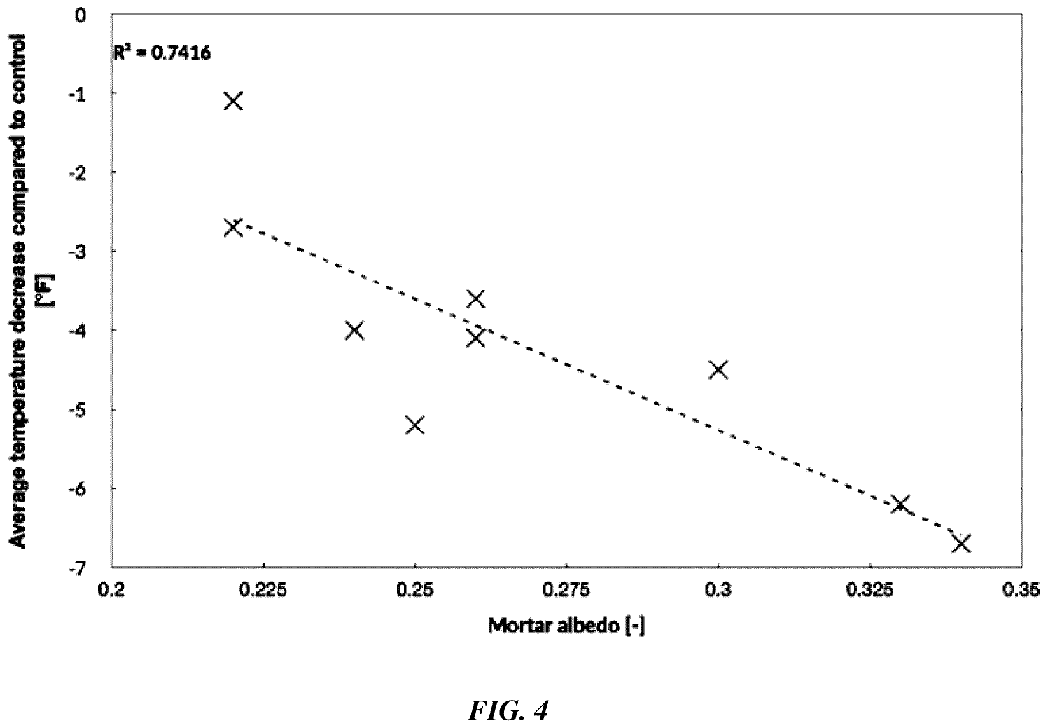

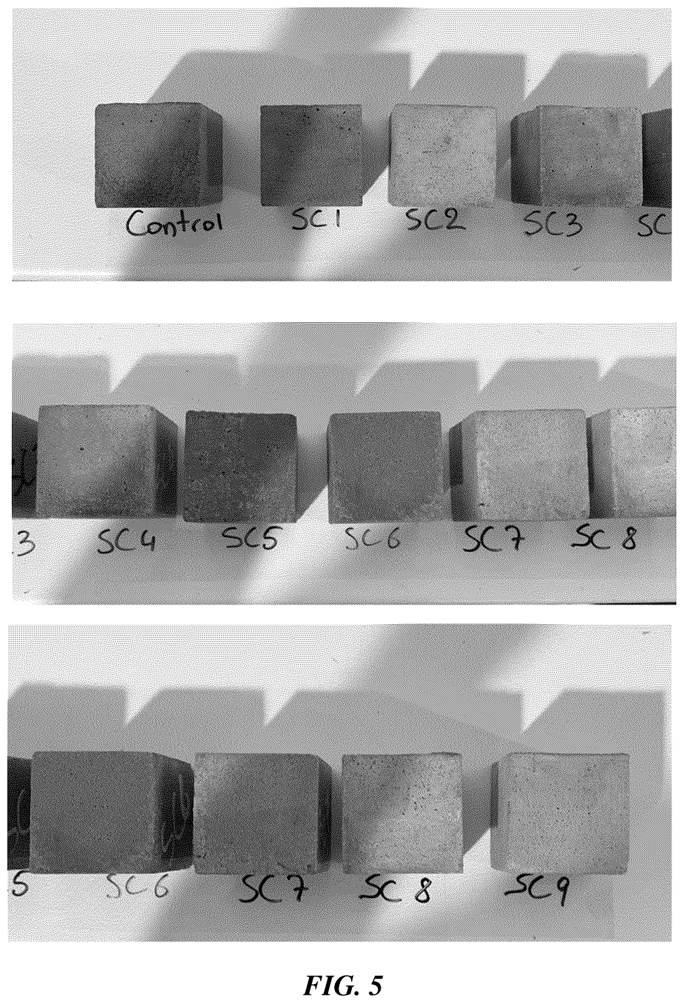

FIG. 4 plots the average change in surface temperature observed throughout FIG. 3 as a function of albedo for each sample. The plot shows that as albedo increases, the average surface temperature change observed throughout FIG. 3 decreased. Having a lower surface temperature over long times (e.g., 6 hours as shown in FIGS. 3-4) would mitigate the increased temperatures observed due to the urban heat island effect, which may lessen energy costs associated with cooling indoor environments, minimize heat-related illnesses, and/or reduce CO₂ emissions related to energy usage. FIG. 5 shows images of the different mortar cube specimens.

The results in this example show the improved albedo of concrete test samples, relative to a control sample, and highlight associated thermal properties that arise due to the improved sample albedo values.

### Example 2

This example describes the cooling effect of tile specimens made with mortar samples comprising a cementitious system composition comprising a metal oxide (i.e., titanium dioxide), an amorphous aluminum silicate material (i.e., pumice), and a carbonate-containing material (i.e., calcium carbonate). The example further describes the measured properties of the tile specimens.

Samples were prepared by casting and curing the mortar samples containing the cementitious composition following the ASTM C305 standard practice. All components were individually weighed using a calibrated laboratory balance scale and following the mixture proportions indicated in TABLE 2 below (ambient temperature between 2° and 27.5° C., humidity not less than 50%). A measured amount of tap water (at approximately 23° C.) was then directly inserted into the mortar mixing bowl and cement was added to water. The mixture was placed in an electrically driven mechanical mortar mixer and mixed for 30 seconds at low speed (140±5 r/min) using a stainless steel paddle. After 30 seconds, a measured quantity of ASTM C778 graded Ottawa test sand (natural silica sand graded to retain 98% on a No. 100 (150μ) sieve, 75% on a No. 50 (300μ) 30% on a No. 40 (425μ) and 2% on a No. 30 (600μ)) was added in the bowl over a 30 second period. After 30 seconds, the mixing speed was switched to high speed (285±10 r/min) for 30 more seconds. After a total of 90 seconds, the mixer was turned off for 90 seconds and the sides of the bowl were scraped down during the first 15 seconds. Finally, the mortar was mixed again at high speed for 60 seconds. After the 240 seconds of mixing, mortar was cast in 12×12×¾ [in] tile molds and kept in a moist environment (23° C., humidity not less than 95%) for 24 hours. Then, the mortar tiles were removed from the molds and cured in tap water (23° C.) buckets for 6 more days. A control sample was made, comprising Portland-Limestone cement, ASTM C778 Standard graded sand and tap water. One test sample was also made, where the sample comprised materials as described in TABLE 2.

TABLE 2
Mix proportions for the 12 × 12 × ¾ in mortar tile specimens.

| Mix ID | PLC [g] | ASTM sand [g] | Water [g] | TiO₂ [g] | Pumice [g] | Limestone [g] |
|---|---|---|---|---|---|---|
| Control | 1,100.0 | 3,025.0 | 572.0 | 0.0 | 0.0 | 0.0 |
| CoolCrete | 770.0 | 3,025.0 | 572.0 | 16.5 | 214.5 | 99.0 |

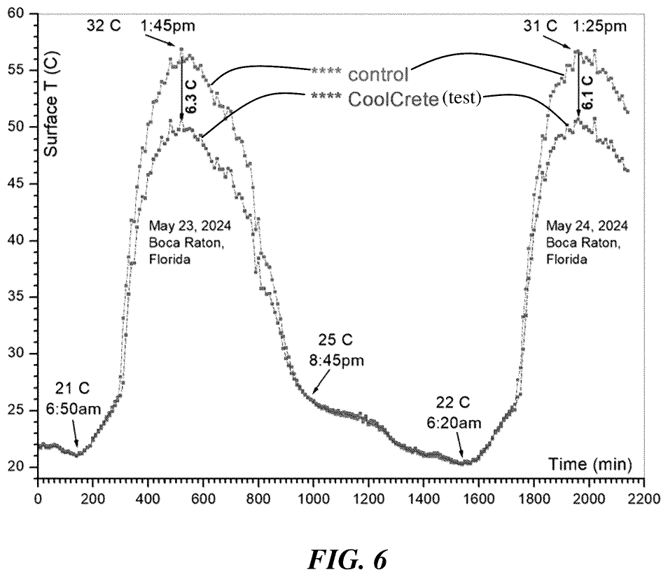

The near-surface temperature of each sample was recorded in 10-minute intervals using i-Button temperature sensors to evaluate the effect of the cementitious system composition on the resultant surface temperature. FIG. 6 shows the surface temperature of each sample as a function of time for two consecutive days. The plot shows the active cooling effect that resulted from the cementitious system composition in the test samples, relative to the control sample. Specifically, the CoolCrete test sample shows a maximum surface temperature difference between itself and the control sample of 6.3 degrees Celsius, despite substantially identical testing conditions (e.g., irradiation by sunlight, temperature of atmosphere and ground, etc.) other than sample composition.

Having a lower surface temperature over long times would mitigate the increased temperatures observed due to the urban heat island effect, thereby lessening energy costs associated with cooling indoor environments, minimize heat-related illnesses, and/or reduce CO₂ emissions related to energy usage. The results in this example showed the decreased surface temperature of mortar tile test samples, relative to a control sample.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A cementitious system composition, the composition comprising:
a silicon-containing material;
a light-reflecting material; and
a thermal emittance enhancing material.

2. A composition, comprising:
a cementitious system composition comprising a silicon-containing material;
a light-reflecting material comprising barium sulfate; and
a thermal emittance enhancing material comprising pumice.

3-4. (canceled)

5. A method for reducing heat generated by concrete, the method comprising:
reflecting at least a portion of incident sunlight from the concrete and re-emitting at least a portion of absorbed solar energy, wherein the concrete comprises a cementitious system composition comprising a silicon-containing material; a light-reflecting material and a thermal emittance enhancing material and has an albedo of at least 0.22.

6. The composition of claim 1, wherein the silicon-containing material comprises waste glass.

7. The composition of claim 1, wherein the light-reflecting material comprises barium sulfate.

8. The composition of claim 1, wherein the cementitious system composition further comprises an inorganic material.

9. The composition of claim 1, wherein the cementitious system composition comprises a zeolite.

10. The composition of claim 1, wherein the cementitious system composition further comprises a metal oxide.

11. The composition of claim 1, wherein the cementitious system composition comprises titanium dioxide.

12. The composition of claim 1, wherein the cementitious system composition comprises Aluminum Oxide, Zinc Oxide, Silicon Dioxide, and/or Iron Oxide.

13. The composition of claim 1, wherein the cementitious system composition further comprises a carbonate-containing compound.

14. The composition of claim 1, wherein the cementitious system composition comprises calcium carbonate.

15. The composition of claim 1, wherein the silicon-containing material is present in the cementitious system composition in an amount of greater than or equal to 0.01 wt % and less than or equal to 40 wt %.

16. The composition of claim 1, wherein the light-reflecting material is present in the cementitious system composition in an amount of greater than or equal to 0.01 wt % and less than or equal to 35 wt %.

17. The composition of claim 1, wherein the inorganic material is present in the cementitious system composition in an amount of greater than or equal to 5 wt % and less than or equal to 90 wt %.

18. The composition of claim 1, wherein the carbonate-containing compound is present in the cementitious system composition in an amount of greater than or equal to 0.01 wt % and less than or equal to 50 wt %.

19. The composition of claim 1, wherein the metal oxide is present in the cementitious system composition in an amount of greater than or equal to 0.01 wt % and less than or equal to 40 wt %.

20. The composition of claim 1, wherein an average particle size of the silicon-containing material, the inorganic material, the carbonate-containing compound, and/or the metal oxide after reducing the particle size of the silicon-containing material, the inorganic material, the carbonate-containing compound, and/or the metal oxide is greater than or equal to 1 μm and less than or equal to 3000 μm.

21. The composition of claim 1, wherein the incident light comprises sunlight.

22. The composition of claim 1, wherein the incident light comprises light of a wavelength of greater than or equal to 10 nm and less than or equal to 400 nm.
